(19) United States
(12) Patent Application Publication
(10) Pub. No.: US 2004/0024673 A1
(43) Pub. Date: Feb. 5, 2004

(54) Method for optimizing the allocation of resources based on market and technology considerations

(75) Inventors: Bernd-Josef M. Huettl, Ridgefield, CT (US); George W. Doerre, Poughkeepsie, NY (US)

Correspondence Address: H. Daniel Schnurmann, Intellectual Property Law, IBM Corporation, Dept. 18G, Building 300-482, 2070 Route 52, Hopewell Junction, NY, 12533, US

(73) Assignee: International Business Machines Corporation, Armonk, NY (US)

(21) Appl. No.: 10/210,718

(22) Filed: Jul. 31, 2002

(51) Int. Cl. G06F 17/60

(52) U.S. Cl. 705/36

(57) ABSTRACT

A method for performing portfolio analysis with a decision model for design automation tools resulting in a design automation tool positioning on a multidimensional decision grid that translates the design automation tool technology into quantified business data needed for making the investment decisions and for optimizing the resource budget within an organization. The decision model is assumed to have been partitioned in two categories: Tool Opportunity Attractiveness (TA) and Tool Implementation Competitiveness (TIC). including the sub-partitions and algorithms. Each partition of the model is assigned to a separate process, each of which may, in general, optimize the resource budget with the result of the tool positioning on the multidimensional decision grid when running independently. The method dictates the actions performed in each of these processes in the decision model evident of multiple sub-partitions with adjustable weighting factors but with predefined rating options resulting in the design automation tool positioning on the multi-layer decision grid tailored for the organization.

### FIELD OF THE INVENTION

This invention is generally related to a method for optimizing the allocation of available resources, and more particularly, to a method for performing a portfolio analysis of design automation tools of integrated chips and electronic systems in view of market, technology and competitive considerations.

### BACKGROUND OF THE INVENTION

Developing a specific design automation tool in the chip and technology industry involves decisions regarding how to allocate a limited resource budget among a collection of costly design automation tools that are required for the design and development of integrated circuit chips to complex electronic systems. Very little qualitative guidance is currently available to make these decisions. More importantly, no methodology and decision model exist at present that comprehensively embrace both the technology and the business aspects of the design automation tool that is commonly applicable to all types of tools to direct the investment decision making with focus on optimizing finite resources.

Most efforts that companies expend to maintain consistency when allocating a budget for design automation tools are based on either experience or on a continuation of the previous budget represented by the formula:

new budget n=budget (n−1)±factor x, where x={1, . . . , n},

with x representing an increasing/decreasing factor of the previous budget (preferably expressed in %).

By way of example, assuming a year 2000 budget for design automation tools to be US $ 100 M. The planning budget for the year 2001=year 2000 budget+factor 5%. The result will then be: year 2001 budget for design automation tools=US 100 M+5%=US $ 105 M.

Corporate entities typically define the budget size for the design tools without the knowledge of the business impact and the return-on-investment. These ‘budget methods’ highlight the absence of analytical and consistent models or methods that quantify the value and the business contribution of the design automation systems within the context of the chip development of the company's business. Nor do those methods optimize the correct resource allocation required for the design automation tools.

The challenges of the budget definition for design automation systems are:

1. Design Automation systems, reflecting a large collection of software tools that enhance and aid in the design and development of complex electronic systems, are critical support tools or simplified ‘ingredients’ for the chip development. Moreover, as typical software tools, they are hardly quantifiable with respect to the added value to the chip (in the case of design automation) or to the added value to the company's business. A budget decision related to the value-add principle is still arbitrary since it does not reflect the real tool value-add in an analytical manner.

2. Design Automation systems can be measured by benchmarks such as the run time needed to complete a certain task, the functionality of tool features, and the like, but these gained results do not imply any improvement or higher efficiency of the chip or ensure higher business profitability. Therefore, the budget definition based on those benchmark are somewhat arbitrary since the results of the benchmarks only reflect a ‘point-in-time’ behavior of the tool in a given, mostly artificial environment.

A consistent model for converting the technology of design automation systems into reliable business data to be used for a given budget and that optimizes this budget does not exist. Therefore, the inventive method bridges the existing gap of the technology quantification into business data applicable to the corporate environment.

Glossary of Terms

Design Automation Tool—A software product that enhances and aids in the development of complex electronic systems.

Electronic Design Automation (EDA)—A large collection of software tools to design and develop complex electronic systems.

Decision Model—A model consisting of two major processes, multiple sub-partitions and algorithms. It also includes a multi-layer decision grid directing the investment decision.

Process—A major component of the decision model. The processes are divided into an “x-y process” referred to as Tool Opportunity Attractiveness (TA) and Tool Implementation Competitiveness (TC). Each reflects one dimension of the multi-layer decision grid and determine the tool positioning on the multi-layer decision grid after the tool values have been assessed and transferred to the multi-layer decision grid.

Sub-partition—A series of sub-processes that define the two major processes, i.e., TA and TC. The number of sub-partitions is indefinite as long as the sum of the sub-partitions determining the process equals 1.

Components of the sub-partition—Components are considered sub-components of the sub-partition when they define the sub-partition. The number of sub-partitions is indefinite as long as the sum of the sub-partitions determining the sub-partition adds up into 1.

Weighting Factors—define the importance of the sub-partition as well as the components within the decision model. The sum of the weighting factors must add to 1.

Multi-layer decision grid—defined as the guiding tool for making an investment decision. It consists of a plurality of layers to position the design tool in accordance with the value received by the decision model.

The preferred multi-layer decision grid is two dimensional—one dimension reflecting TA and one reflecting TC.

### SUMMARY OF THE INVENTION

In one aspect of the invention, there is provided a method for performing a portfolio analysis by way of a decision model customized for design automation tools. The resulting design automation tool is then positioned in a multidimensional decision grid. Thus, the design automation tool translates a technology assessment into quantified business data needed for making the investment decisions and for optimizing the resource budget within a corporate entity.

The decision model is assumed to have been partitioned into the Tool Opportunity Attractiveness (TA) and the Tool Implementation Competitiveness (TC) including the sub-partitions and algorithms. Each partition of the model is assigned to a separate process, each intended to optimize the resource budget.

The inventive method dictates the actions performed by each process of the decision model, evident of multiple sub-partitions, with adjustable weighting factors, but with predefined rating options resulting in the design automation tool positioning on the multi-layer decision grid tailored for the competitive entity. A particular refinement of the inventive method provides an efficient execution of the methodology, a consistent assessment of type-indifferent design automation tools with predefined rating option accomplishing a common understanding across different users. The precision of the rating options translates technology into quantifiable data, shares the common decision model among an heterogeneous set of users, and achieves a consistent quality of the results inducing the optimization of the resource budget. Additionally, it also provides a recurrent update of the values without having to interface with the requesting entity, because of the dynamic link capabilities of some sub-partitions to the data source used for determining the value of the process.

The computation of TA for the design tool requires sub-partition values assessing the business and technology implication and potential of the design tool. In particular, in the early business and technology implication analysis mode, the computation of the TA value requires information about the significance of the functionality of the design tool due to the silicon output, indicating the technology value of the tool and the tool level of avoidance that indicates the business value of the tool. In the late business and technology implication analysis mode, the computation of the TA value requires information about the business potential of the design tool indicated by the number of comparable design tools and by corresponding market data such as market size and growth within a predefined time period.

Optionally, in the late business and technology implication analysis mode, the inventive method provides a dynamic link to the data source used for determining the value of the sub-partitions and updates the tool positioning on the multi-layer decision grid with or without a request from the entity.

Computation of TC for a design tool requires the sub-partition values assessing the design tool behavior with respect to the technical features and functions and implications on integrated system solutions. In particular, in the early technical implication analysis mode, the computation of the TC value requires information about the manipulation of the design tool capabilities due to targeted tool behavior indicating the functional tool competitiveness. In the late technical implication analysis mode, the computation of TC requires information about the design tool behavior within the scope of the targeted integrated system solutions, indicating the operational tool competitiveness.

The portfolio analysis results are provided to a requesting entity. It includes means for updating the design tool position information when changes are made in the decision model to allow its use with other requesting entities which wish to monitor the effects of changes made by other requesters on tool values on the decision model.

The requesting entity may be a designer or a manager or another program, all attempting to optimize the resource budget of the design tool software technology and requesting to monitor its progress. This may be as simple as a report generation system which requests the information of a design automation tool position and generates a report summarizing the positions of the assessed design automation tools. Thus, the inventive method is a portfolio analysis utility which may be used by other applications.

The computation of TA translates technology values of the design automation tool into business data to determine the economical value of the tool. To quantify the economical value, a broad knowledge is required which is typically accomplished by a heterogeneous set of users assessing the design automation tool. The computation of the TC value measures technical features of comparable tools as well as translates/applies technical features to targeted integrated system solutions. To quantify its technical capability, a broad knowledge is required which typically can be accomplished by a heterogeneous set of users assessing the design automation tool.

Although the invention is described in terms of design automation tool portfolio analysis, the methodology and the decision model are applicable to any assessment of software products wherein technology components of the software product are to be translated into quantified data needed for investment decision making. Indeed, the present invention can be viewed as a method for doing business, since factors that are essential in assessing to the business can now be evaluated and quantified in order to reach the right business decisions.

### OBJECTS OF THE INVENTION

Accordingly, it is an object of the invention to provide a method for performing an analysis of pertinent factors that are inputted into a decision matrix to optimize a software system and, more particularly, the design automation of integrated chips, electronic systems and technology tools.

It is another object to provide an automated approach for quantifying business data needed for making investment decisions, for allocating and optimizing resources and maintain these within the budget of an organization.

It is still another object to provide a method that provides an efficient use of consistently executing the method, leading to a consistent assessment of type-indifferent design automation tools with predefined rating options providing a common understanding across different users of the design tools.

It is a further object to quantify with precision the rating options translating technology into quantifiable business data, leading to a consistent quality of the results inducing the optimization of the resource budget.

It is yet another object to provide a common decision model that is used and shared among a heterogeneous set of users at different times and that consistently ensures the same quality of the results.

It is a more particular object to provide to design automation tool values which measure the design tool opportunity attractiveness (TA) and design tool implementation competitiveness (TC) in order to optimize the budget resources which are allocated for developing the design tool software systems

### BRIEF DESCRIPTION OF THE DRAWINGS

The foregoing and other objects, features and advantages of the invention will be better understood from the following detailed description of a preferred embodiment of the invention when taken in conjunction with the accompanying drawings, in which:

FIG. 1 is a flow chart illustrating the overall process steps of the present invention and the respective outcomes.

FIG. 2a is a preferred embodiment for capturing the inventory of available design tools and the criteria for identifying the user assessing the tool values.

FIG. 2b shows a preferred embodiment of a multi-layer decision grid to derive the optimization of the resource allocation.

FIG. 3 shows a preferred implementation of the Tool Opportunity Attractiveness (TA).

FIG. 4 shows a preferred implementation of the Tool Implementation Competitiveness (TC).

FIG. 5 shows a the process of defining the weighting factor of TA and TC.

FIG. 6 illustrates the use of the decision model and its functionality for assessing the tool values with respect to TA and TC.

FIG. 7 illustrates a decision grid mapping TA versus TC.

FIG. 8 illustrates the process to apply the assessed tool values as the outcome of the TA and TC to the decision grid.

FIG. 9 shows the results of the assessed tool values on the decision grid and direct the investment decision on the resource allocation.

### DETAILED DESCRIPTION OF THE INVENTION

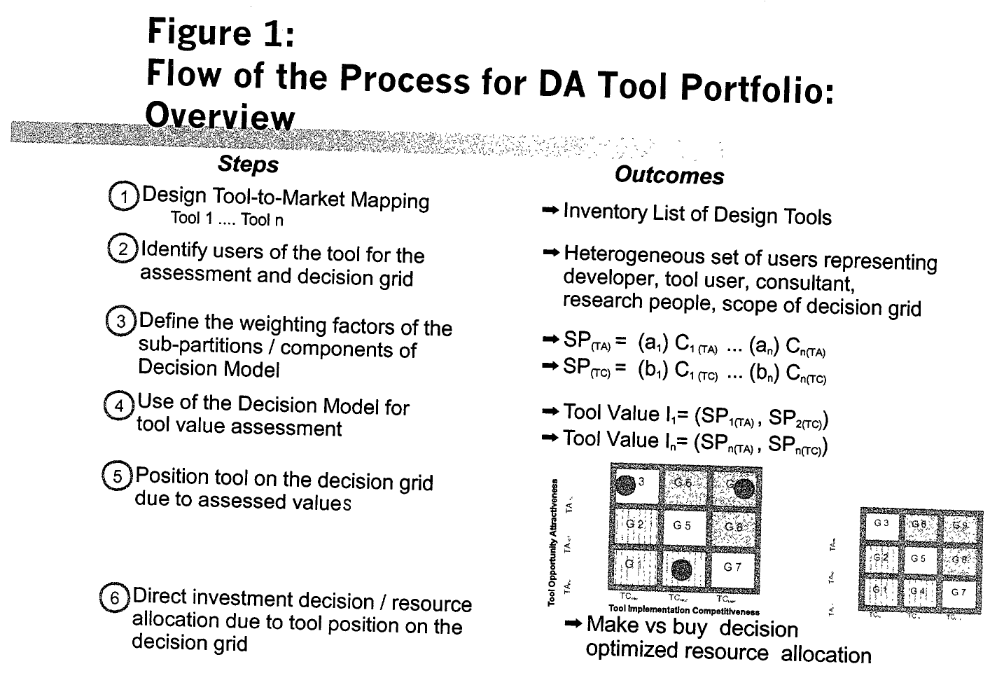

FIG. 1 illustrates the process steps applicable to a Design Automation (DA) tool portfolio, and the respective outcome upon completion of each process step.

The process steps described hereinafter are advantageously split into several semi-independent sections:

Section 1. An initial computation defines the process distribution of the sub-partitions and the components of the decision model by:

a.) using the most current information already received from other processes without waiting for other information that has not yet been propagated (i.e., the values are already available either by using the present method or by any other for assessing the tool), or

b) using the initial information from one portion of the qualified entity utilizing the decision model and the process.

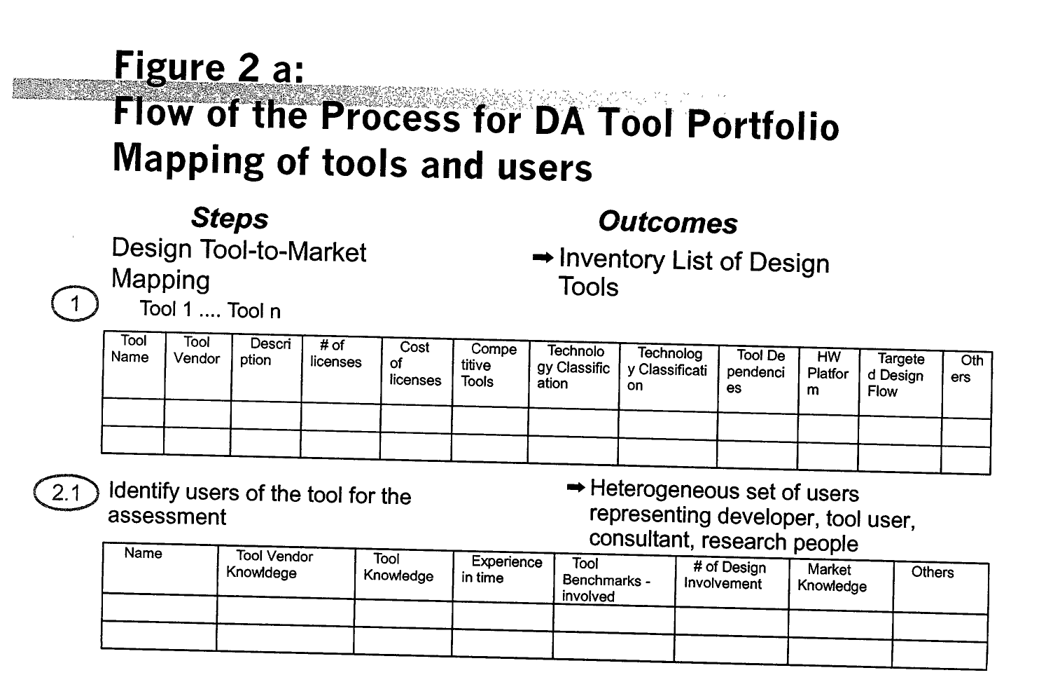

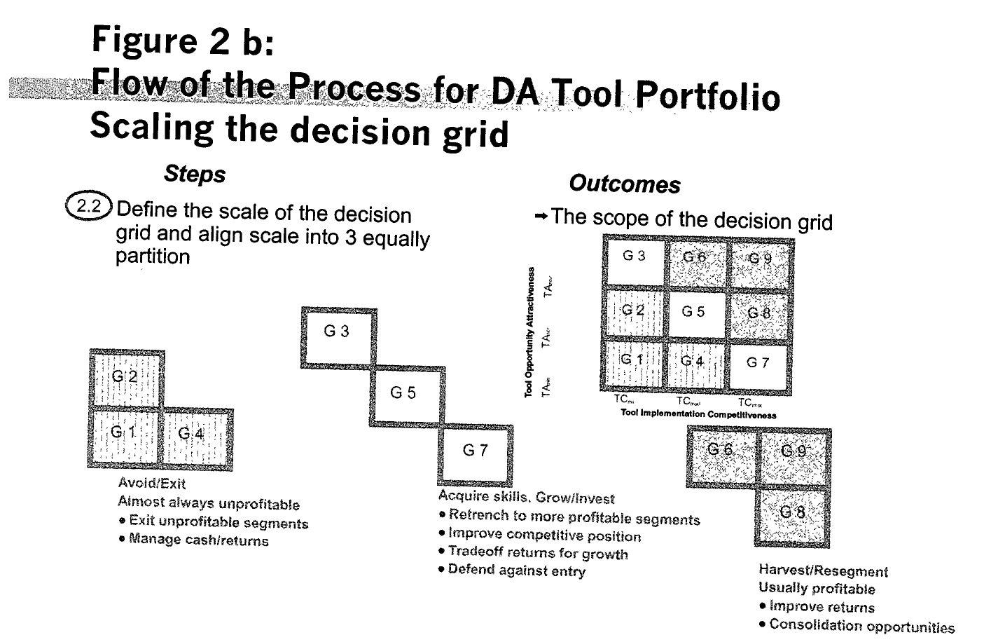

This process is shown in FIGS. 2a-2b which illustrate the initial computation that initiates the process steps is described for the case when no values exist.

Section 2. Detects the values of the sub-partitions and the components of the processes due to the methodology and decision model. It also includes the selection and definition of the design automation tool or software product in general and qualification of the entity using the decision model, the definition of the process distribution (weighting factors), determining the rating options and initial computation of the sub-partitions and the components of the processes.

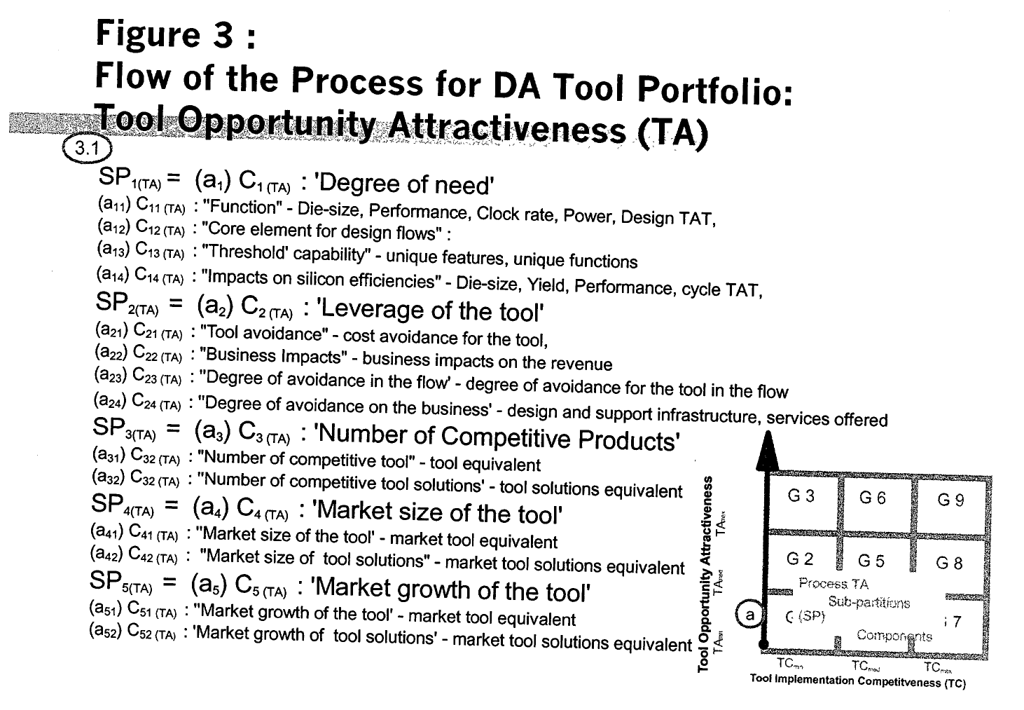

The method of execution to detect the values is shown with reference to FIGS. 3 through 5.

Section 3. Computing all the generated and updated values resulting in the investment decision to be performed.

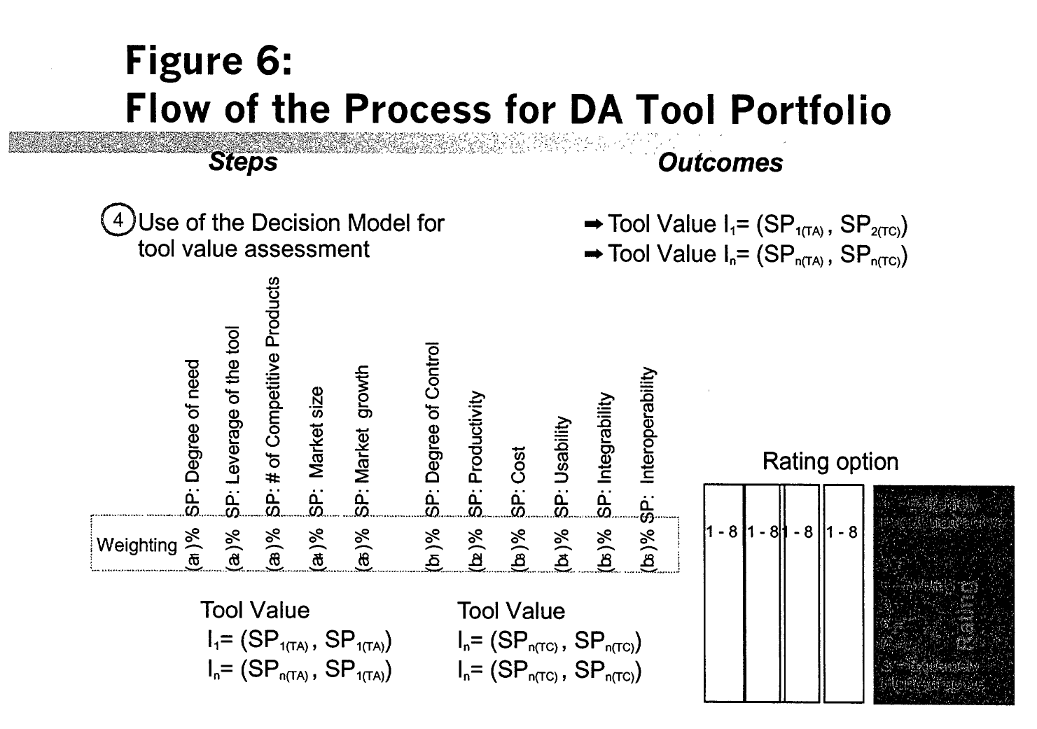

This is shown in FIGS. 6 through 9, which illustrate the method of detecting the values and for executing the decision on the resource allocation.

Section 1 is used as a stand-alone in the case where global values on the design automation tool or software product in general exists as a result of model requirements. In general, it is used jointly with Section 2 in case where global values may not exist and where values of a defined tool are requested for business and/or application considerations by a given entity.

Section 2 is used as a stand alone in the case where the entity has already generated some values on the design automation tool or software product as previously described in the Background of the Invention. In general, it is used in the case where global values exist but the entity requires a reevaluation of the values.

Section 3 is used once the values have been generated as described in Sections 1 or 2 or by some other methods such as MPT (Modern Portfolio Theory) developed by Professor Harry Markowitz of the City University of New York in the 1950s.

If the entity and/or application or application requesting design automation tool values make simultaneous non-synchronized changes in portions of the decision model in the different processes, any updates are performed as in Section 1.

If the entity or application requesting design automation tool values synchronizes the changes in the portions of the decision model in the various processes such that all change activity is suspended while an updated design automation tool value is requested, the updates being performed as described in Section 2.

Incremental updating of design tool values within a single process are performed using Section 2.

When combining these components, the invention operates as follows:

1. An application for an investment decision on the design automation tool system requests TC and TA values, as described in the methodology and decision model.

2. The decision model requires specific information to compute TA and TC and direct the investment decision. Each process includes a plurality of sub-partitions including components and weighting factors propagating the values either by identified sources or by part of the qualified entity resulting in appropriate tool positioning on the multi-layer grid (as described in FIG. 2b). The predefined rating options for the sub-partitions and components are tailored to the environment of the business entity.

3. If there are sub-partitions without a dynamic link to the data sources, Section 2 will not be able to be completed because the remaining sub-partitions would be waiting for their “initial value”/predecessor to return them a value. When any process/sub-partition detects that it is unable to continue, it initiates the steps described in the section “Finding initial values of a sub-partition” (Section 1). This activity is interrupted when new values are received, allowing the process to continue.

4. TA and TC determine the tool positioning on the multi-layer decision grid and direct the allocation (i.e., investment, resource) decision.

5. One or more changes are made to the decision model in at least one sub-partition. Each change consists of small constituent changes. For instance, inserting a new component involves disconnecting the sub-partition from the decision model, redefining the distribution allocation of the sub-partition, adding the new component to the sub-partition, connecting the sub-partition to the decision model from which the original process of the decision model was disconnected. Each of the constituent changes causes a change to the decision model but the decision model is not in the correct state until all constituent changes of a larger change have been completed. These changes occur simultaneously in the decision model.

6. While the applications make changes in Section 5, they (or some other application) request updated values as described in Section 1a. These requests are then honored.

7. The simultaneous changes in multiple partitions stop. The application now requests an updated tool value in the decision model.

8. The request is attended to as in Section 1b, as described above.

The following generalized example illustrates the generality and applicability of the invention to multiple industries—in this case, the game software industry:

Assess the available supplier of the game software, e.g., Nintendo's Gameboy—Pokeman, Sony-Playstation 2 NHL 2002, etc. (see FIG. 2a)

Gather a sample of customers, e.g., children, male, female, etc. (see FIG. 2a)

Determine the scope and scale of the decision grid needed for optimizing the resource allocation, e.g., the scale spans from a low of 1 (e.g., software requiring one week education and constant support from the supplier) to 8, an investment decision (i.e., world class, such as software running self-explanatory instructions and not requiring any support) (FIG. 2b)

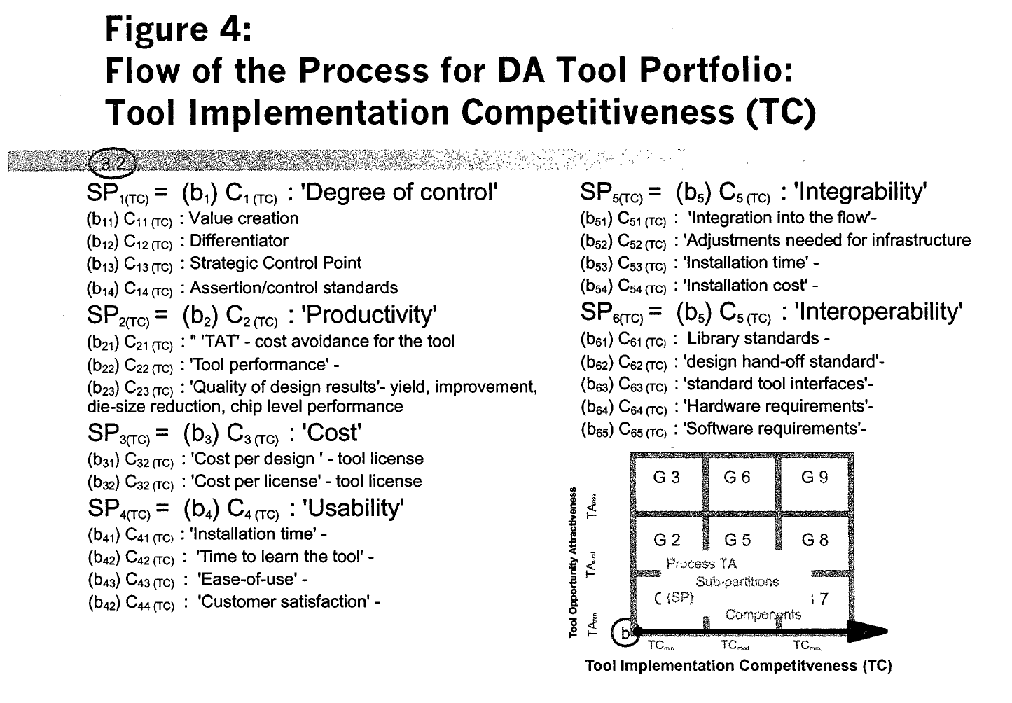

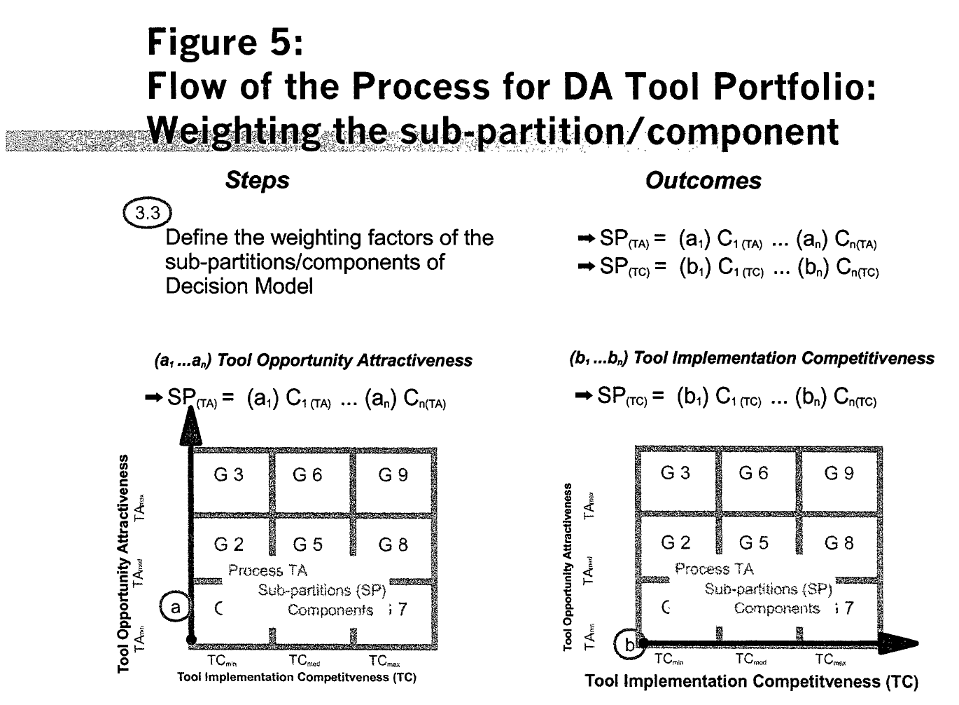

Determine the sensitivity of the sub-partitions and the chosen components (FIGS. 3 and 4) by weighting them (FIG. 5)

Rate the selected game software using the sub-partitions and the selected components (FIGS. 3 and 4).

Sum the assessed rates of the sub-partitions and the chosen components (FIGS. 3 and 4).

Transfer the values of the sub-partitions to the decision grid

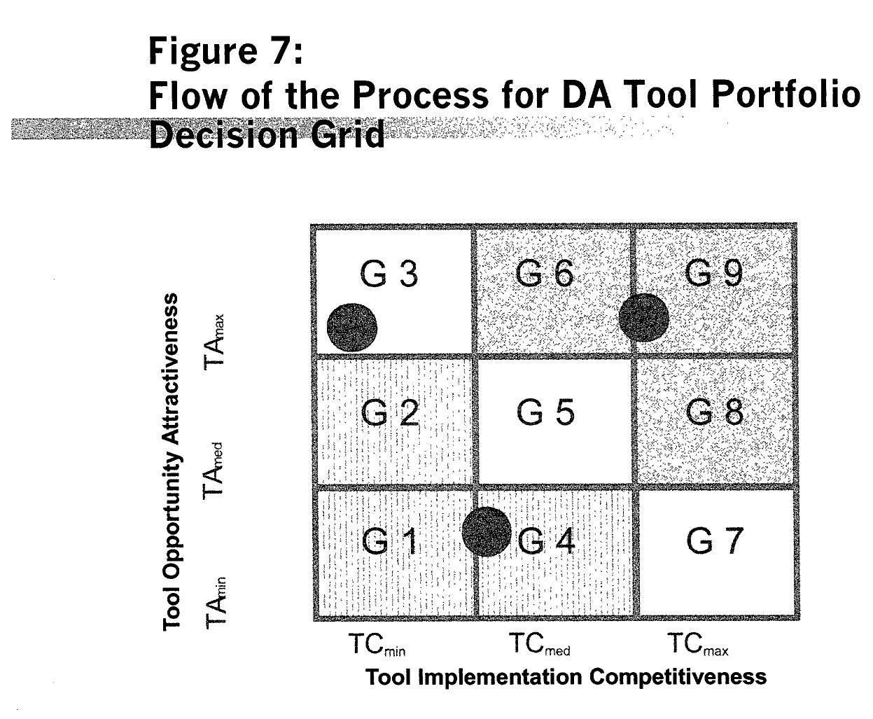

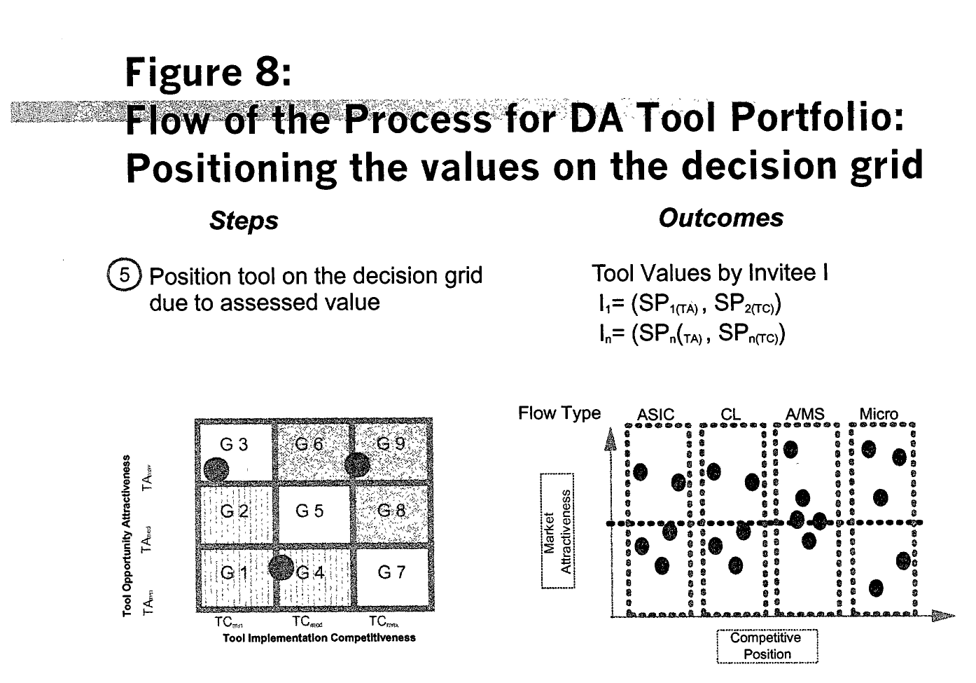

Transfer the values of the sub-partitions to the decision grid (FIGS. 7 and 8).

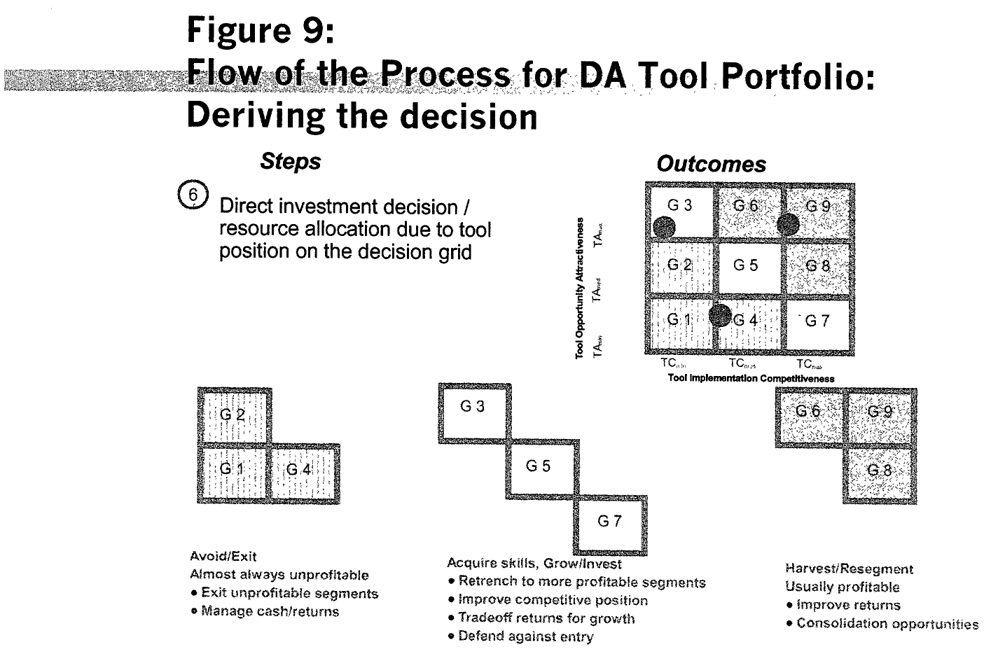

Direct investment decision/resource allocation due to assessed position on the decision grid (FIG. 9)

Algorithms and Computation

Referring to FIG. 3 a preferred implementation of the TA is described by the following formula:

Tool Opportunity Attractiveness Formula:

TA=[(a₁)SP_{1(TA)}+(a₂)SP_{2(TA)})+ . . . +(aₙ)SP_{n(TA)}]

(SP)=Sub-partition of a process

(C)=Component of a sub-partition

(a)=Weighting factor of a given sub-partition (SP) and/or component (C)

Requirements:

Sum of a_{i n}=1

SP_{n(TA)}=[(a₁₁)(C_{11(TA)})+(a₁₂)(C_{12(TA)})+ . . . (a₁ₙ) (C_{1n(TA)})]

Sum of a_{11 n}=1

Cₙ can be indefinitely sub-partitioned as long as [(a₁₁) (C_{11(TA)})+ . . . +(a₁ₙ)(C_{1n(TA)})]=1

Value range for rating option of C=[(x)ₘᵢₙ . . . (x)ₘₐₓ]

(x)ₘᵢₙ=[1 . . . n]

(x)ₘₐₓ=[1 . . . n]

(x)ₘᵢₙ<(x)ₘₐₓ

Sub-partitions and components of the Tool Opportunity Attractiveness (TA):

SP_{1(TA)}=(a₁)C_{1(TA)}: ‘Degree of Need’

(a₁₁)C_{11(TA)}: Function—the impacts on die-size, performance, clock rate, power, design Turn-around-time (TAT)

(a₁₂)C_{12(TA)} Core element for design flows: the “must step” in the design flow

(a₁₃)C_{13(TA)}: Threshold capability—the unique features, unique functions of the tool

(a₁₄)C_{14(TA)}: Impacts on silicon efficiencies—the impacts on die-size, yield,

performance, design cycle TAT,

SP_{2(TA)}=(a₂)C_{2(TA)}: ‘Leverage of the Tool’

(a₂₁)C_{21(TA)}: Tool avoidance—the cost avoidance for the tool

(a₂₁)C_{12(TA)}: Business Impacts—the business impacts of the organization on the revenue

(a₂₃) C_{13(TA)}: Degree of avoidance in the flow—degree of avoidance for the tool in the flow

(a₂₄)C_{14(TA)}: Degree of avoidance on the business—the design and support infrastructure, services offered,

SP_{3(TA)}=(a₃)C_{3(TA)}: ‘Number of Competitive Products’

(a₃₁)C_{31(TA)}: Number of competitive tool—the equivalent tool(s)

(a₃₂)C_{32(TA)}: Number of competitive tool solutions—the equivalent tool solutions

SP_{4(TA)}=(a₄)C_{4(TA)}: ‘Market Size of the Tool’

(a₄₁)C_{41(TA)}: Market size of the tool—the equivalent market tool

(a₄₂)C_{42(TA)}: Market size of tool solutions—the equivalent market tool solutions

SP_{5(TA)}=(a₅)C_{5(TA)}: ‘Market Growth of the Tool’

(a₅₁)C_{51(TA)}: Market growth of the tool—the equivalent market tool

(a₅₂)C_{52(TA)}: Market growth of tool solutions—the equivalent market tool solutions

Referring to FIG. 4, a preferred implementation of the TC is described by the following formula.

TC=[(b₁)SP_{1(TC)}+(a₂)SP_{2(TC)})+ . . . +(aₙ)SP_{n(TC)}]

wherein

(SP)=Sub-partition of a process

(C)=Component of a sub-partition

(b)=Weighting factor of a given sub-partition (SP) and/or component (C)

Requirements:

Sum of a_{1 n}=1

SP_{n(TC)}=[(b₁₁)(C_{11(TC)})+(b₁₂)(C_{12(TC)})+. . . (b₁ₙ)(C_{1n(TC)})]

Sum of a_{11 n}=1

Cₙ can be indefinitely sub-partitioned as long as [(b₁₁)(C_{11(TC)})+ . . . +(b₁ₙ)(C_{1n(TC)})]=1

Value range for rating option of C=[(x)ₘᵢₙ . . . (x)ₘₐₓ]

(x)ₘᵢₙ=[1 . . . n]

(x)ₘₐₓ=[1 . . . n]

(x)ₘᵢₙ<(x)ₘₐₓ

Sub-partitions and components of TC:

SP_{1(TC)}=(b₁)C_{2(TC)}: ‘Degree of Control’

(b₂₁)C_{21(TC)}: Value creation—the compatibility, software, usage, and bandwidth, innovation, tool investment, quality of processes, products or services, functionality, features, Automation, Repeatability, Ease of use, Precision, High resolution, Fit with current standards

(b₂₂)C_{22(TC)}: Differentiator—the unique features and/or functions of the tool

(b₂₃)C_{23(TC)}: Strategic Control Point—the tool influence on the market, market direction

(b₂₄)C_{24(TC)}: Assertion/control standards—the fit with current standards

SP_{2(TC)}=(a₂)C_{2(TA)}: ‘Productivity’

(b₂₁)C_{21(TA)}: Turn-around-time TAT—the cost avoidance for the tool

(b₂₁)C_{12(TA)}: Tool performance—run time for features/functionality needed in the design

(b₂₃)C_{13(TA)}: Quality of design results—the yield improvement, the die-size reduction, the chip level performance

SP_{3(TC)}=(a₃)C_{3(TA)}: Cost

(b₃₁)C_{31(TA)}: Cost per design—the tool license

(b₃₂)C_{32(TA)}: Cost per license—the tool license

SP_{4(TC)}=(a₄)C_{4(TA)}: ‘Usability of the Tool’

(b₄₁)C_{41(TA)}: Installation time—the time to install tool in the network environment

(b₄₂)C_{42(TA)}: Time to learn the tool—the time to understand the basics of the tool

(b₄₃)C_{43(TA)}: Ease-of-use—the user friendliness, the GUI, guided instruction, icons

(b₄₄)C_{44(TA)}: Customer satisfaction—the overall rating of the design tools described by the various sub-partitions

SP_{5(TC)}=(a₅)C_{5(TA)}: ‘Integrability of the Tool’

(b₅₁)C_{51(TA)}: Integration into the flow—the effort (times+resources) for the integration of the tool in the design flow

(b₅₂)C_{52(TA)}: Adjustments needed for infrastructure—the HW and SW changes needed to integrate the tool in the design environment

(b₅₃)C_{53(TA)}: Installation time—the time to install tool in the design environment

(b₅₄)C_{54(TA)}: Installation cost—the cost associated with the implementation of the tool in the design environment

SP_{6(TC)}=(a₆)C_{6(TA)}: ‘Inter-Operability of the Tool’

(b₆₁)C_{61(TA)}: Library and Core compatibility—the tool compatibility with libraries and cores

(b₆₂)C_{62(TA)}: design hand-off standard—the format of the input-output data between tools, e.g., files format, code line access,

(b₆₃)C_{63(TA)}: standard tool interfaces—the fit with current standards

(b₆₄)C_{64(TA)}: Hardware requirements—the hardware platforms e.g. CPU, Memory, etc.

(b₆₅)C_{65(TA)}: Software requirements—Software Operating Systems e.g. UNIX, Linux, AIX

Formula: Weighting factors for the Tool Opportunity Attractiveness (TA) and the Tool Implementation Competitiveness (TC).

Referring to FIG. 5 a preferred process of defining the weighting factors of the Tool Opportunity Attractiveness (TA) and the Tool Implementation Competitiveness (TC) is described hereinafter.

The weighting factors are computed in a variety of ways which are believed to be outside of the scope of the invention. One way is to define weighting factors as the average distribution across all invitees.

Weighting factors for TA with averaged distribution of I

(a₁)=I₁(a₁)+I₂(a₁)+ . . . +Iₙ(a₁)/Sum(I_{1 n})

(a₂)=I₁(a₂)+I₂(a₂)+ . . . +Iₙ(a₂)/Sum(I_{1 n}) . . .

(aₙ)=I₁(aₙ)+I₂(aₙ)+ . . . +Iₙ(aₙ)/Sum(I_{1 n})

Weighting factors for TC with averaged distribution of I

(b₁)=I₁(b₁)+I₂(b₁)+ . . . +Iₙ(b₁)/Sum(I_{1 n})

(b₂)=I₁(b₂)+I₂(b₂)+ . . . +Iₙ(b₂)/Sum(I_{1 n}) . . .

(bₙ)=I₁(bₙ)+I₂(bₙ)+ . . . +Iₙ(bₙ)/Sum(I_{1 n})

Invitees I: I_{1 n}

Sum of a_{1 n}=1

Sum of b_{1 n}=1

Formula: Scale of the Rating Options for Assessing the Tool Value

Referring to FIG. 6, the scale of rating options on TA and TC is defined as described in Section 2. By way of example, the rating scale spans from 1 (the minimum) to 8 (the maximum).

Example of a preferred Rating Scale:

| Rating | | Description |
|---|---|---|
| 1 | Unacceptable | Awkward data translation, 1:1 not possible, |
| | | scripts needed with constant tweaking |
| 2 | Acceptable | Awkward data translation, 1:1 not possible, |
| | to minimum | scripts needed with no tweaking |
| 3 | Somewhat | Awkward data translation, 1:1 possible |
| | Acceptable | |
| 4 | Acccptable | Data translation works, excessive runtime |
| 5 | Acceptable | Data translation works, competitive runtime |
| | to most | |
| 6 | Very good | File transfer works transparent to the user |
| 7 | Excellent | In-Core data, separate UI/GUI |
| 8 | World Class | In-Core data, compatible UI/GUI |

Formula: Tool Positioning on the Multi-Layer Grid by Transferring the Assessed Tool Values of the Tool Opportunity Attractiveness (TA) and the Tool Implementation Competitiveness (TC) to the Decision Grid

The values assessed by the users for the targeted design tool are transferred to and positioned individually for each user on the multi-layer decision grid. The objective is to represent the individual values for deriving the appropriate investment decision. Both Tool Attractiveness Formula and Tool Competitiveness Formula range from Cₘᵢₙ to Cₘₐₓ determined by the scale of the predefined rating options.

With reference to the assessed TC and TA values, the inventive method directs the tool positioning on the multi-layer decision grid.

Referring now to the decision grid shown in FIG. 4, the grid is divided into multiple grids that reflect the sum of all possible assessed values expressed by the formula:

G_{1 n}=f(TA₁, TC₂) . . . (TAₙ, TCₙ),

where G=grid

Referring to FIG. 7 illustrating an example of the multi-layer decision grid, the scale of the multi-layer decision grid is computed in a variety of ways, which are believed to be outside of the scope of the invention.

Grid 1: TA={1, 2} and TC={1, 2}

Grid 2: TA={3, 4, 5} and TC={1, 2}

Grid 3: TA={6, 7, 8} and TC={1, 2}

Grid 4: TA={1, 2} and TC={3, 4, 5}

Grid 5: TA={3, 4, 5} and TC={3, 4, 5}

Grid 6: TA={6, 7, 8} and TC={3, 4, 5}

Grid 7: TA={1, 2} and TC={6, 7, 8}

Grid 8: TA={3, 4, 5} and TC={6, 7, 8}

Grid 9: TA={1, 2, 3} and TC={6, 7, 8}

The inventive method directs the investment decision as the assessed value(s) of the targeted tool position the tool on the multi-layer decision grid. The decision grid is divided into multiple grids reflecting the sum of all possible assessed values expressed by the formula. The assessed values of the users are positioned on decision grid according to the listed ranges of the grids.

Detailed Description of the Methodology

The preferred implementation of the inventive method consisting of the following steps will now be described in conjunction with FIG. 1.

Step 1: Design Tool-to-Market Mapping: Develop, Identify and Assess the Inventory of the Design Automation Tools Within the Organization

Before executing an analysis of the portfolio, an accurate listing of the design automation tools in use or planned to be used is generated. The development of the inventory list on design automation tools within the organization is performed as follows:

1.1. Identify Existing Software License Agreements for Design Automation Tools.

Typically, the business operation or the legal department of the organization manages the filing and archiving of software license agreements for design automation tools. If such organizations do not exist, the users of design automation tools need to be identified and certified for using design tools legitimately.

The sorting criteria for identifying the user of design automation tools and the design tool software is achieved either through a physical computer check on the installed software or through the IT department if a central network is implemented. In the event of an internal design tool development, the development teams are asked to identify the name of the design automation tools and tool users.

1.2. Definition of the Content of the Inventory List for Design Automation Tools.

To create an inventory list for design tools, the content needs to be defined since this inventory list represents the starting point for the portfolio analysis. The key information that is to be collected is:

Name of Design Tool including SW version

Name of the Tool Vendor

Description of the design tool

Internal Usage based on users/Peak Usage

Number of licenses

Cost per license/per design tool (for internal tools: Development/Support/Maintenance Cost)

Best of Breed Competitor #1

Best of Breed Competitor #2

Technology Tool Classification: verification-analysis-creation tool

Business Tool Classification: critical/non˜ and strategic/non˜

Impacts—Dependencies on other Tools

Contacts for tool related issues

Hardware Platform Supported

Used in Design Flows (ASIC Flow, Analog/Mixed Flow. Etc.)

1.3. Assessment of the Content of the Inventory List for Design Automation Tools.

After gathering the information, the user of the portfolio analysis sorts the information relative to:

The Technology Tool Classification defining the type of design automation tool, e.g., Verification, Analysis and Creation of the design automation tool,

The Business Tool Classification defining the type of a design automation tool and assessing them as critical/non-critical and strategic/non-strategic tool,

The Impacts and Dependencies of a design automation tool on other design automation tools.

Sorting leads to the first ranking of the design automation tools. It determines the type of the tool (analysis-verification-creation), the strategic criticality of the tool and the schedule for the design automation tool to be assessed by portfolio analysis. It is recommended to prioritize the design automation tools upon the technology and business classification. The design automation tools with the highest ranking are utilized as the starting point.

Step 2: Identify Users of the Tool for the Assessment and Decision Grid

2.1. Identify the Invitees for the Targeted Portfolio Analysis Sessions

The invitees for the targeted design automation tool portfolio are critical to the success of the tool portfolio. The unique challenge is to aggregate knowledge that encompass both the technology and the business relevant scope of the tool. The technology scope consists of the design automation tool features and functions, the usability of the tool, the tool behavior in the used design flow environment with focus on inter-operability and integrability. Business scope targets elements include productivity, cost, degree of control, degree of need and leverage of the tool. In the later part of the business, scope an industry knowledge is required to complete the portfolio analysis. Herein, the number of competitive products, the market size and market growth needs to be known. Besides the required knowledge on the targeted design automation tool the decision model also requires a knowledge on the competitive design tools.

To capture a comprehensive knowledge and maximize the quality of the portfolio analysis, the decision model requires a heterogeneous team of invitees comprised of user of the design automation tool, and technical advisers such industry consultants, developers, research personnel.

To conduct successfully the portfolio analysis, it is mandatory that each invitee be educated on the used questionnaire, the questions and rating options.

2.2. Define the Scale of the Decision Grid and Align the Scale to Three Equal Partitions

Referring back to FIG. 2b, there is shown the preferred scope of a multi-layer decision grid to derive the optimization of the resource allocation. The preferred multi-layer decision grid is comprised of two dimensions—one dimension reflecting TA and the other TC. The dimensions are aligned to the scale in the following way:

One-third of the scale reflect a low or negative TA and TC implying an inefficient resource allocation with respect to the assessed Design Tool and directing a change of the resource allocation

One-third of the scale reflect a medium or neutral TA and TC implying an inefficient resource allocation with respect to the assessed Design Tool and directing only a change of the resource allocation if requested by the entity.

One-third of the scale reflect a high or positive TA and TC implying an efficient resource allocation with respect to the assessed Design Tool and directing no change of the resource allocation

Usage of Tool Opportunity Attractiveness (TA) and Tool Implementation Competitiveness (TC)

Templates are defined by the user of the decision model. For each portfolio session, the invitees define the weighting factors of each sub-partition and each component.

The requirements for the weighting factors are for TA: Sum of a_{1 n}=1 and for TC: Sum of b_{1 n}=1 (see formulas below):

Tool Opportunity Attractiveness Formula:

TA=[(a₁)SP_{1(TA)}+(a₂)SP_{2(TA)})+ . . . +(aₙ)SP_{n(TA)}]

(SP)=Sub-partition of a process

(C)=Component of a sub-partition

(a)=Weighting factor of a given sub-partition (SP) and/or component (C)

Requirements:

Sum of a_{1 n}=1

SP_{n(TA)}=[(a₁₁)(C_{11(TA)})+(a₁₂)(C_{12(TA)})+ . . . (a₁ₙ)(C_{1n(TA)})]

Sum of a_{11 n}=1

Cₙ can be indefinitely sub-partitioned as long as [(a₁₁)(C_{11(TA)})+ . . . +(a₁ₙ)(C_{1n(TA)})]=1

Value range for rating option of C=[(x)ₘᵢₙ . . . (x)ₘₐₓ] with

(x)ₘᵢₙ=[1 . . . n]

(x)ₘₐₓ=[1 . . . n]

(x)ₘᵢₙ<(x)ₘₐₓ

Tool Implementation Competitiveness Formula:

TC=[(b₁)SP_{1(TC)}+(b₂)SP_{2(TC)})+ . . . +(bₙ)SP_{n(TC)}]

(SP)=Sub-partition of a process

(C)=Component of a sub-partition

(b)=Weighting factor of a given sub-partition (SP) and/or component (C)

Requirements:

Sum of a_{1 n}=1

SP_{n(TA)}=[(a₁₁)(C_{11(TA)})+(a₁₂)(C_{12(TA)})+ . . . (a₁ₙ)(C_{1n(TA)})]

Sum of a_{11 n}=1

Cₙ can be indefinitely sub-partitioned as long as [(b₁₁)(C_{11(TC)})+ . . . +(b₁ₙ)(C_{1n(TC)})]=1

Value range for rating option of C=[(x)ₘᵢₙ . . . (x)ₘₐₓ]

(x)ₘᵢₙ=[1 . . . n]

(x)ₘₐₓ=[1 . . . n]

(x)ₘᵢₙ<(x)ₘₐₓ

Step 3: Define the Weighting Factors of the Sub-Partitions/Components of the Decision Model

The definition of the weighting factors can be computed by a variety of ways. One way to define the weighting factors could be the average distribution of all the invitees.

Weighting factors for TA with averaged distribution of I

(a₁)=I₁(a₁)+I₂(a₁)+ . . . +Iₙ(a₁)/Sum(I_{1 n})

(a₂)=I₁(a₂)+I₂(a₂)+ . . . +Iₙ(a₂)/Sum(I_{1 n}) . . .

(aₙ)=I₁(aₙ)+I₂(aₙ)+ . . . +Iₙ(aₙ)/Sum(I_{1 n})

Weighting factors for TC with averaged distribution of I

(b₁)=I₁(b₁)+I₂(b₁)+ . . . +Iₙ(b₁)/Sum(I_{1 n})

(b₂)=I₁(b₂)+I₂(b₂)+ . . . +Iₙ(b₂)/Sum(I_{1 n}) . . .

(bₙ)=I₁(bₙ)+I₂(bₙ)+ . . . +Iₙ(bₙ)/Sum(I_{1 n})

Invitees I: I_{1 n}

Sum of a_{1 n}=1

Sum of b_{1 n}=1

Step 4: Use of the Decision Model for Tool Value Assessment

The invitees for the targeted design automation tool portfolio go through the complete TA and TC processes including the sub-partitions and components to provide the requested information. As previously described, the decision model containing predefined rating options facilitates a common understanding of the potential value assessed by the various users. The predefined rating options are tailored to the organization, and are selected from existing templates. Alternatively, they are defined by the user of the decision model.

At this point, the invitees execute the method described heretofore. In this manner, the invitees create the values that will be positioned on the decision grid.

Step 5: Position Tool on the Decision Grid Due to the Assessed Values

The values assessed by the users for the targeted design tool are transferred to and positioned individually for each user on the multi-layer decision grid. The objective is to represent the individual values for deriving the appropriate investment decision. As previously described, the user representation is heterogeneous and therefore the assessed values have to be separately and individually shown on the decision grid. The decision model contains predefined rating options which facilitates a common understanding of the potential value assessed by the various users. The predefined rating options are tailored to the organization and are chosen from existing templates or can be defined by the user of the decision model. Based on this, both the TA and TC values will range from Cₘᵢₙ to Cₘₐₓ determined by the used scale of the predefined rating options.

Example of Rating Scale in general:

| Rating | | Description |
|---|---|---|
| 1 | Unacceptable | Awkward data translation, 1:1 not possible, |
| | | scripts needed with constant tweaking |
| 2 | Acceptable | Awkward data translation, 1:1 not possible, |
| | to minimum | scripts needed with no tweaking |
| 3 | Somewhat | Awkward data translation, 1:1 possible |
| | Acceptable | |
| 4 | Acccptable | Data translation works, excessive runtime |
| 5 | Acceptable | Data translation works, competitive runtime |
| | to most | |
| 6 | Very good | File transfer works transparent to the user |
| 7 | Excellent | In-Core data, separate UI/GUI |
| 8 | World Class | In-Core data, compatible UI/GUI |

Related to the used rating scale the multi-layer decision grid reflects as follows:

Grid 1: TA={1, 2} and TC={1, 2}

Grid 2: TA={3, 4, 5} and TC={1, 2}

Grid 3: TA={6, 7, 8} and TC={1, 2}

Grid 4:TA={1, 2} and TC={3, 4, 5}

Grid 5: TA={3, 4, 5} and TC={3, 4, 5}

Grid 6: TA={6, 7, 8} and TC={3, 4, 5}

Grid 7: TA={1, 2} and TC={6, 7, 8}

Grid 8: TA={3, 4, 5} and TC={6, 7, 8}

Grid 9: TA={1, 2, 3} and TC={6, 7, 8}

Step 6: Direct the Investment/Resource Allocation Decision from the Tool Positioning on the Decision Grid

The organization decides what the decision will be on the assessed tools. The rating scale the multi-layer decision grid is reflected in the following way:

Grid 1: TA={1, 2} and TC={1, 2}

Grid 2: TA={3, 4, 5} and TC={1, 2}

Grid 3: TA={6, 7, 8} and TC={1, 2}

Grid 4: TA={1, 2} and TC={3, 4, 5}

Grid 5: TA={3, 4, 5} and TC={3, 4, 5}

Grid 6: TA={6, 7, 8} and TC={3, 4, 5}

Grid 7: TA={1, 2} and TC={6, 7, 8}

Grid 8: TA={3, 4, 5} and TC={6, 7, 8}

Grid 9: TA={1, 2, 3} and TC={6, 7, 8}

The assessed values of the users are then positioned on the decision grid according to the listed ranges of the grids.

C. Detailed Description of the Decision Model

1. Tool Implementation Competitiveness

The voter compares the targeted design automation tool to the “Best of Breed” competitive design automation tools for the rating with respect to “unique values”, cost, productivity, usability, integrability and inter-operability. The goal is to express the competitiveness of the targeted design automation tool compared to the “Best of Breed” competitive design automation tools.

The sub-partition “Degree of control” (Weighting Factor (a₁) in %) is assessing the unique features of the targeted design automation tool relative to the competitive design automation tools. Additionally, the decision criteria asks for the advantage that the organization has in the market compared to the competitive design automation tools such as strategic control point, value proposition, assertion/control standards, support infrastructure etc.

The sub-partition “Productivity” (Weighting Factor (a₂) in %) addresses the impact on the designer and the design team productivity of the targeted design automation tool relative to the competitive design automation tools. The goal is to measure the targeted design automation tool to the competitive design automation tools with respect to the design TAT.

The sub-partition “Cost” (Weighting Factor (a₃) in %) focuses on assessing the Total Cost of Ownership. This cost analysis is supposed to indicate how efficiently the organization spends its investments on the design automation tool development.

The sub-partition “Usability” (Weighting Factor (a₄) in %) addresses the Ease of Use and user friendliness of the design automation tool compared to the competitive design automation tools.

The sub-partition “Integrability” (Weighting Factor (a₅) in %) with focus on “installability” evaluates how well the targeted design automation tool relative to the competitive design tools can be integrated in the various design flows.

The sub-partition “Inter-operability” (Weighting Factor (a₆) in %) with focus on the file level (“Plug and Play”) evaluates how the design automation tool relative to the competitive design automation tools is inter-operable in conjunction with other tools in the various design flows.

Example of the rating scale in general:

| Rating | | Description |
|---|---|---|
| 1 | Unacceptable | Awkward data translation, 1:1 not possible, |
| | | scripts needed with constant tweaking |
| 2 | Acceptable | Awkward data translation, 1:1 not possible, |
| | to minimum | scripts needed with no tweaking |
| 3 | Somewhat | Awkward data translation, 1:1 possible |
| | Acceptable | |
| 4 | Acccptable | Data translation works, excessive runtime |
| 5 | Acceptable | Data translation works, competitive runtime |
| | to most | |
| 6 | Very good | File transfer works transparent to the user |
| 7 | Excellent | In-Core data, separate UI/GUI |
| 8 | World Class | In-Core data, compatible UI/GUI |

While the presented invention has been described in terms of a preferred embodiment, those skilled in the art will readily recognize that many changes and modifications are possible, to quantitatively assess the Tool Opportunity Attractiveness measured against the Tool Implementation Competitiveness as well as the factors that should and should not be incorporated in the decision grid, all of which remain within the spirit and the scope of the present invention, as defined by the accompanying claims.

What is claimed is:

1. A method for optimizing the allocation of resources comprising the steps of:
a) providing analyzing tools and grading their respective attractiveness with respect to a first set of predetermined weighted parameters and rating options;
b) assessing and quantifying a set of competitive market entities in accordance with a second set of predetermined weighted parameters and rating options;
c) deriving a decision based on the attractiveness of the graded tools and the quantification of the competitive market entities; and
d) allocating resources as a function of the derived decision.

2. The method as recited in claim 1 is a software system.

3. The method as recited in claim 2, wherein the software system is a design automation system.

4. The method as recited in claim 2, wherein the software system includes a technology system.

5. The method as recited in claim 4, further comprising mapping design tools as a function of technology considerations to a design methodology.

6. The method as recited in claim 5, wherein mapping of the design tools is a function of market considerations.

7. The method as recited in claim 5, wherein mapping of the design tools is a function of technology considerations.

8. A method for optimizing resources in a software system comprising the steps of:
a} providing analyzing tools and grading their respective attractiveness with respect to a first set of predetermined weighted parameters and rating options;
b) assessing and quantifying market factors and competitive entities in accordance with a second set of predetermined weighted parameters and rating options;
c) generating a portfolio built upon the rating options that combine technology and competitive market considerations resulting in a set of quantified data;
d) interactively displaying the tool positioning of the analyzed tools on the decision grid associated with estimates of resource and allocation requirements;
e) deriving a decision based on the attractiveness of the graded tools and the quantification of the competitive market entities built on the generated portfolio; and
f) allocating resources as a function of the derived decision.

9 The method of claim 8 wherein the step of grading further comprising the steps of:
a) determining the major categories as a function of the attractiveness and competitive market consideration characterizing the value of the tool to be analyzed
b) within each category, partitioning to the smallest number of separable significant criteria;
c) adaptively determining the weighting by referring to a data source to determine the influence of each criteria in isolation; and
d) adapting the range of criteria rating to the actual range of the alternatives being considered.

10. The method as recited in claim 8 further comprising the steps of:
a) forming sub-partitions associated to the Tool Attractiveness (TA) and Tool Competitiveness (TC),
b) linking the sub-partitions to a data source that determines a grading value of the TA and TC of each sub-partition; and
c) summing the grading values and entering them in the decision grid.

11 A method for optimizing resources comprising the steps of:
a) providing analyzing tools and grading their respective attractiveness with respect to a first set of predetermined parameters;
b) assessing and quantifying a set of competitive market entities in accordance with a second set of predetermined parameters;
c) generating a portfolio array built upon predefined rating options that combine technology and competitive market considerations resulting in a set of quantified data;
d) deriving a decision based on the attractiveness of the graded tools and the quantified data representing the technology and the competitive market considerations; and
e) allocating resources as a function of the derived decision.

12. A program storage device readable by a machine, tangibly embodying a program of instructions executable by the machine to perform method steps for optimizing the allocation of resources, the method steps comprising:
a) providing analyzing tools and grading their respective attractiveness with respect to a first set of predetermined parameters;
b) assessing and quantifying a set of competitive market entities in accordance with a second set of predetermined parameters;
c) deriving a decision based on the attractiveness of the graded tools and the quantification of the competitive market entities; and
d) allocating resources as a function of the derived decision.

13. A computer-based system for optimizing the allocation of resources, comprising:
a) a template for analyzing tools;
b) a positioning file for positioning the analyzed tools coupled to a decision grid, the decision grid containing data that measures the attractiveness and the competitiveness of the tool;
c) a solver coupled to a method engine and operable to receive priorities of sub-partitions and ratings, and for positioning the tools in a decision grid; and
d) a dynamic link to a predefined data source for determining the value of the sub-partitions resulting in creating an updated tool positioning on the decision grid.
